(19) United States
(12) Patent Application Publication
(10) Pub. No.: US 2005/0166898 A1
(43) Pub. Date: Aug. 4, 2005

(54) Fuel injection system and cylinder head with a central fuel reservoir

(76) Inventors: Christian Braeuer, Ernsthofen (AT); Stefan Holl, Ottnang (AT)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/509,589

(22) PCT Filed: Mar. 18, 2003
(86) PCT No.: PCT/DE03/00877

(30) Foreign Application Priority Data
Sep. 16, 2002 (DE) 102 42 894.8

(51) Int. Cl. F02M 55/02

(52) U.S. Cl. 123/456; 123/470

(57) ABSTRACT

A fuel injection system for an internal combustion engine and to a cylinder head for such a fuel injection system, in which a central fuel reservoir is provided between a feed pump and a plurality of injectors to be supplied with fuel, which each communicate with the central fuel reservoir via respective high-pressure lines, and the injectors are mounted in a cylinder head of the engine for injecting fuel into a plurality of combustion chambers, and the fuel reservoir and/or the high-pressure lines are at least partly integrated into the cylinder head of the engine.

### FIELD OF THE INVENTION

For supplying fuel to combustion chambers, for instance in direct-injection internal combustion engines, injection systems are used that have a central pressure reservoir (common rail), by way of which highly compressed fuel is delivered to the various injectors of the engine. In such engines, the highest possible injection pressure is generally advantageous, since that makes higher engine power levels and reduced emissions possible.

### BACKGROUND OF THE INVENTION

In currently known injection systems for supplying fuel to internal combustion engines, it is known to embody a central pressure reservoir in the form of a tube which communicates with the various injectors of the engine via high-pressure lines and is supplied with fuel form the fuel tank via a feed pump. A tube serving for instance as a high-pressure reservoir is known to be disposed parallel to and along a cylinder head of a self-igniting internal combustion engine. The tube walls enclose the storage volume of the high-pressure fuel reservoir, by way of which a common high pressure is generated centrally for the various injectors, which inject the fuel into the various combustion chambers of the engine. The injection pressure advantageously varies, depending on the load and rpm of the self-igniting internal combustion engine.

A known fuel injection system is disposed in German published, unexamined patent application DE 199 10 970 A1. Here the fuel is pumped by a feed pump out of a tank into a central pressure reservoir chamber and from there is carried via a plurality of high-pressure lines to respective injectors for injection into the combustion chambers of the engine. The pressure reservoir chamber of the fuel reservoir is defined by the walls of the tube. To further increase the injection pressure, a further pressure booster unit may be provided between the fuel reservoir and the injectors. A disadvantage of this fuel injection system is that the fuel reservoir, which is disposed on the outside of and in the vicinity of the respective cylinder of the cylinder head, requires additional space in the engine compartment. Moreover, in such fuel reservoirs, the maximum height of the pressure level is limited by the wall thicknesses of the tube forming the reservoir chamber and by the various connecting lines.

Given the ever-increasing demands made in terms of internal combustion engine emissions and noise, there is a need for further provisions in the injection system so that the even more-stringent limit values expected in future can still be met.

### SUMMARY OF THE INVENTION

Embodying a fuel injection system in accordance with the invention as defined by the characteristics of claim 1 advantageously reduces the space required for the injection system. The fuel injection system as proposed herein can be designed for both self-igniting internal combustion engines and direct-injection gasoline engines. If the fuel injection system proposed according to the invention is used in self-igniting internal combustion engines, the fuel reservoir is designed as a high-pressure fuel reservoir, so as to withstand the pressures required. If the fuel injection system proposed according to the invention is used in direct-injection gasoline engines, the fuel reservoir can be designed with a wall thickness that takes the lower fuel pressure level that is required in that case into account.

Because the fuel reservoir is at least partly integrated with the cylinder head of the engine, the pressure reservoir located on the outside, in the form of a tube, in previously known systems used in self-igniting internal combustion engines can be eliminated. Moreover, a complicated fastening of the reservoir and connecting tubes is not needed, because of the integrated embodiment of the reservoir chamber of the fuel reservoir in the interior of the cylinder head. Another advantage is that the fuel reservoir can be disposed directly in the vicinity of the various injectors, and as a result the connecting distances on the high-pressure side form the fuel reservoir into the respective combustion chamber via the injectors are reduced. The space available in the cylinder head of internal combustion engines thus optimally utilized in terms of realizing a fuel injection system. The lines leading to and from the fuel reservoir are likewise advantageously embodied in the cylinder head of the engine. Alternatively, the reservoir chamber of the fuel reservoir can be disposed directly on the various injectors, so that the connecting lines on the high-pressure side are then omitted entirely.

Another advantage of the invention is that the high pressures prevailing in the fuel reservoir are absorbed by all the material comprising the cylinder head, which material surrounds the reservoir chamber integrated into it. Thus the stresses that arise in the reservoir chamber need not be absorbed by the direct wall of a tubular fuel reservoir.

In an advantageous feature of the invention, the fuel reservoir is embodied by a recess in the cylinder head. The shape and size of the recess can vary, depending on the particular storage volume required. Thus by simply providing a recess in the material comprising the cylinder head, the fuel reservoir can be disposed directly and in the vicinity of the injectors of the injection system. Additional fastenings for the fuel reservoir are dispensed with entirely. Advantageously, the recess of the fuel reservoir is a cylindrical, elongated recess in the vicinity of and along the injectors, which as a rule are arranged in a row. The connecting distances of the high-pressure lines to the respective injectors are thus as short as possible, and are all equal in length. In an embodiment of the invention that is advantageous in this respect, the high-pressure lines that connect the fuel reservoir to the various injectors are embodied as connecting conduits that are integral with the material comprising the cylinder head.

In a further advantageous feature of the invention, the fuel reservoir is embodied as a cylindrical, elongated bore in the cylinder head. By drilling, the shape and position of the fuel reservoir can be produced with precision, and it can be disposed as close as possible to the respective receiving bores for the injectors by way of which the fuel is injected into the combustion chambers. As an alternative to this, the fuel reservoir is formed by an insert part in the operation of casting the cylinder head. This makes production extremely simple and requires no additional machining steps.

In a further advantageous feature of the invention, the fuel reservoir, for instance in common rail injection systems for self-igniting internal combustion engines, is embodied by a cylindrical tube which is integrated into the cylinder head of the engine in a suitable bore or recess. The stresses and loads from the highly compressed fuel are thus advantageously absorbed by all the material, comprising the cylinder head, that surrounds the reservoir tube. The cylindrical tube may be provided on its ends with suitable attachment devices and connection points, making production and installation simple.

The cylinder head having the characteristics of claim 11, which is intended for operating an internal combustion engine in conjunction with a fuel injection system, has a fuel reservoir and respective high-pressure lines that are at least partly integrated into the cylinder head. “Integrated embodiment” is understood here to mean that the reservoir chamber of the fuel reservoir and/or the high-pressure lines are provided by means of recesses or bores in the material comprising the cylinder head of the engine itself. As a result, the required installation volume for the injection system in the engine compartment is reduced, and additional fasteners for a separate high-pressure reservoir located on the outside are dispensed with. The recesses and conduits of high-pressure connecting lines and of the storage volume of the high-pressure fuel reservoir in self-igniting internal combustion engines, for instance, can advantageously be realized by means of insert cores in the operation of casting the cylinder head, or alternatively by means of cylindrical bores, or by a combination of the two.

### DRAWING

The invention will be describe in further detail below in conjunction with the drawing.

Shown are:

FIG. 1, a schematic illustration of a first embodiment of a fuel injection system according to the invention, with a fuel reservoir in the form of a recess in the cylinder head;

FIG. 2, a sectional view of a second embodiment of a fuel injection system according to the invention, with a fuel reservoir integrated into the cylinder head directly beside various injectors.

### EMBODIMENTS

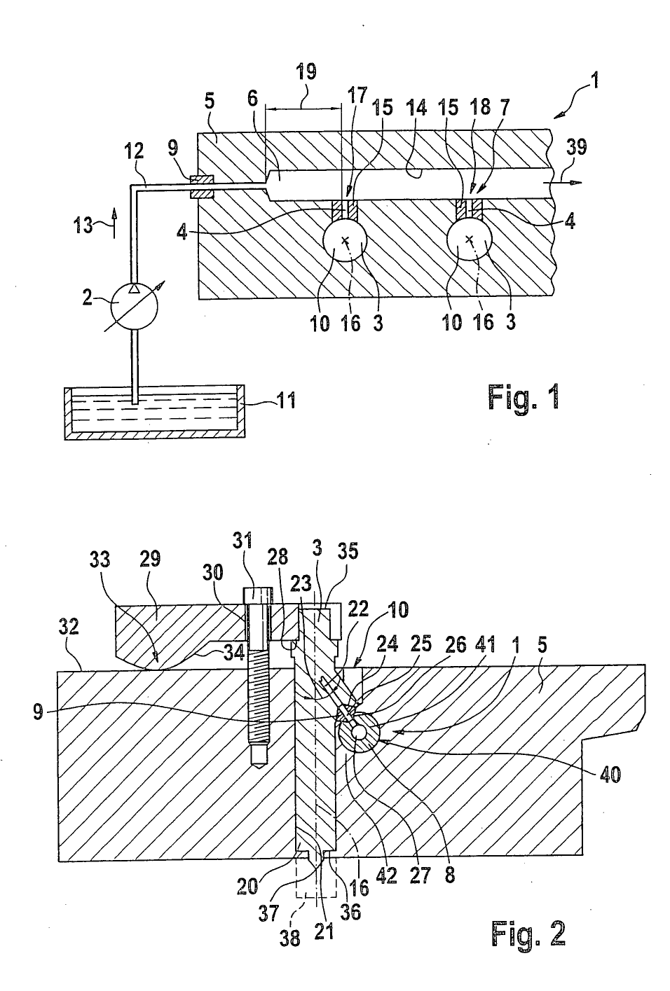

In FIG. 1, a first embodiment of a fuel injection system according to the invention is shown schematically, having a fuel reservoir integrated, in the form of a recess, into a cylinder head. In self-igniting internal combustion engines, the fuel reservoir is embodied as a high-pressure reservoir (common rail); in direct-injection gasoline engines, the fuel reservoir is designed for a lower pressure level. The fuel injection system proposed according to the invention can be used both in self-igniting internal combustion engines and in direct-injection gasoline engines.

Fuel is pumped from a fuel tank 11 by a feed pump 2 and is furnished in compressed form in a central fuel reservoir 1, which in self-igniting internal combustion engines is designed as a high-pressure reservoir, and from there is delivered to the combustion chambers 38 of the engine. The feed pumped by the feed pump 2 passes via a sealing body 9 to reach the high-pressure fuel reservoir 1, which according to the invention is embodied as a recess 6 in the interior of, and integrated with, a cylinder head 5 of an internal combustion engine. The recess 6, which—in the case of self-igniting internal combustion engines forms the high-pressure fuel reservoir 1 and in the case of direct-injection gasoline engines forms the fuel reservoir—is an elongated cylindrical recess 6 in the embodiment shown in FIG. 1 and is disposed in the vicinity of and parallel to fuel injectors 3 that are in line with one another. The fuel reservoir 1 communicates via high-pressure lines 4 with the various fuel injectors 3 for carrying the compressed fuel onward. In the embodiment shown in FIG. 1, the high-pressure lines 4 are likewise embodied as connecting conduits 7 integrated into the cylinder head 5. The recess 6 and the connecting conduits 7, which form the high-pressure lines 4, can, in the embodiment shown, be produced in the form of insert cores during the operation of casting the cylinder head 5 of the engine. Alternatively, they can equally well be formed by subsequent drilling of the cylinder head 5. Alternatively, they can equally well be formed by subsequent drilling of the cylinder head 5.

The fuel volume pumped from the fuel tank 11 by the feed pump 2 reaches a high-pressure line segment 12, in which fuel that is at high pressure is pumped in the fuel feeding direction 13. At the entrance to the high-pressure fuel line segment 12 into the cylinder head 5, the sealing body 9 is provided on the cylinder head, and through it the fuel volume, at high pressure, flows into the cylindrical recess 6 inside the cylinder head 5 of the self-igniting internal combustion engine. When the cylinder head 5 of the engine is produced by casting, the cylindrical recess 6 can for instance by produced by means of an insert core, whose pulling direction is represented in FIG. 1 by reference numeral 39. Surface machining of the inner wall 14 of the cylindrical recess 6 can be omitted, if the insert core, which can be removed from the cylinder head 5 in the pulling direction 39, is pretreated with a parting agent.

A first branch 17 leading to the fuel injector 3 is located at a spacing marked by reference numeral 19 from the inlet end of the cylindrical recess 6. The spacing 19 between the first branch 17 and the inlet end of the cylindrical recess 6 is dependent on the pressure level to which the cylindrical recess 6, serving as the high-pressure fuel reservoir 1 (in the case of self-igniting internal combustion engines) or as the fuel reservoir 1 (in the case of direct-injection gasoline engines), is subjected via the feed pump 2. The first branch 17 to the fuel injector 3 is followed by a further, second branch 18 to a second fuel injector 3. The axes of symmetry of the fuel injectors 3, which are provided in a number corresponding to the number of cylinders of the combustion chambers of an engine that are to be supplied with fuel, are identified by reference numeral 16. The fuel injectors 3 are each let into fastening openings 10 that are made in the cylinder head 5.

Insert pieces 15 can advantageously be inserted into the material of the cylinder head 5, forming the high-pressure lines 4 between the interior of the high-pressure fuel reservoir 1 or fuel reservoir and the fuel injectors 3 by way of which lines the fuel injectors are subjected to fuel at high pressure. In comparison to previously known high-pressure fuel reservoirs located on the outside, the length of the high-pressure lines 4 is extremely short, so that the high pressure level prevailing in the high-pressure fuel reservoir 1 or fuel reservoir (that is, the cylindrical recess 6) is present directly at the fuel injector 3. The insert pieces 15 can likewise be made by means of insert cores, which can be disposed at the appropriate points in the mold in the operation of casting the cylinder heads 5. The essentially cylindrically configured insert pieces 15 that form the high-pressure lines 4 each surround respective connecting conduits 7, which are embodied with a diameter large enough for an adequate fuel supply.

Advantageously, by means of the provisions of the invention it is attained that the material defining the cylindrical recess 6 inside the cylinder head 5 can be utilized to absorb the pressure forces that prevail in the high-pressure fuel reservoir 1 or the fuel reservoir 1. The same is true for the material of the cylinder head 5 in the self-igniting internal combustion engine that surrounds both the insert pieces 15 and the fuel injectors 3. The stresses arising from the high pressure prevailing in the interior of the cylindrical recess 6 are absorbed not only via the direct walls of the high-pressure reservoir, as is usual in reservoirs located outside the cylinder head 5 in the prior art, but is also intercepted by all the surrounding material comprising the cylinder head 5. Because of the loss of the material comprising the cylinder head 5 in the casting operation, intrinsic stresses are induced, which contribute to reducing stress.

In FIG. 2, a second embodiment of the invention is shown in a sectional view, with a fuel reservoir which extends along the injectors disposed in the cylinder head and is integrated into the cylinder head.

The high-pressure delivery of fuel to the fuel injectors in this variant embodiment of the invention includes a fuel reservoir 1, which is formed by a cylindrical tube 8 that, in the vicinity of the fuel injectors 3, is let into a recess 6 or 40, of suitable size, in the cylinder head 5 of the self-igniting internal combustion engine. The fuel reservoir 1 formed by the cylindrical tube 8 communicates directly, via sealing bodies 9, with the various fuel injectors 3, so that separate connecting conduits or lines are not needed.

The injector 3 shown as an example in FIG. 2 is inserted into the cylinder head 5 in a fastening opening 10.

As can be seen from the further exemplary embodiment of the invention, shown in section in FIG. 2, the fuel injector 3 is introduced into the fastening opening 10 in the cylinder head 5. The wall 21 of the injector body 20 of the fuel injector 3 rests then on the material, comprising the cylinder head 5, that defines the fastening opening 10. To make it easier to introduce the injector body 20, which includes a lateral attachment flange, into the fastening opening 10, the fastening opening 10 is embodied in its upper region with an enlarged cross section, in comparison to the cross section of the injector body 20 below the fuel reservoir 1 that is integrated into the cylinder head 5; in self-igniting internal combustion engines, this fuel reservoir is embodied as a high-pressure reservoir chamber, while in direct-injection gasoline engines it is embodied as a reservoir chamber that is subjected to a lower fuel pressure level. In an attachment region embodied laterally on the injector body 20, a high-pressure bore 22 extends at an angle 23 to the axis of symmetry 16 of the injector body 20. The high-pressure bore 22 comes to an end in the injector body 20 at a protuberance 24 formed into the injector body on the side toward the injector. The protuberance 24 toward the injector surrounds the top side of the sealing body 9, which in turn is penetrated by a through bore 26 that is aligned with the high-pressure bore 22. Below the sealing body 9, the fuel reservoir 1 extends—perpendicular to the plane of the drawing in FIG. 2—in the form of a cylindrical tube 8 that is integrated into the cylinder head 5. The cylindrical tube 8 acting as the fuel reservoir 1 has a plurality of recesses 26 toward the reservoir, which are distributed over its circumferential surface. The recesses 26 toward the reservoir are embodied on the circumferential surface of the cylindrical tube 8 in a number corresponding to the number of fuel injectors 3 to be supplied with fuel. The sealing bodies 9 represent the connecting elements between the high-pressure fuel reservoir 1 and the injector body 20 of the fuel injector 3.

In the variant embodiment shown in FIG. 2, The cylindrical tube 8 functioning as a fuel reservoir 1, whose wall is identified by reference numeral 41, is let into an opening 40 extending perpendicular to the plane of FIG. 2. The opening 40 may be a cylindrical recess 6 as shown in FIG. 1, or a longitudinal bore made in the cylinder head 1, for instance of a self-igniting internal combustion engine. Analogously, the cylindrical recess 6 may be let into the cylinder head 5 of a direct-injection gasoline engine. The wall 41 of the cylindrical tube 8 is surrounded virtually completely by the material 42 comprising the cylinder head 5 of the engine, which material absorbs the incident material stresses when the cylindrical tube 8 is acted upon by fuel at high pressure. The cylindrical tube 8 surrounds a hollow chamber 27, which is acted upon by fuel at high pressure via the fuel feed pump 2 shown in FIG. 1. With the provisions according to the invention, it is advantageously possible to have higher pressures in the fuel reservoir 1, since the material, surrounding it, of the cylinder head 5 can be used in its entirety for absorbing stresses. With the fuel reservoir 1 integrated into the cylinder head 5 in accordance with the invention, less installation space outside the cylinder head is needed, since a tubular high-pressure reservoir chamber, located on the outside, in self-igniting internal combustion engines and corresponding supply and high-pressure lines are omitted.

The injector body 20 of the fuel injector 3 is fastened in the cylinder head 5 via a clamping body 29. The clamping body 29 includes a receptacle portion 36, which fits over the head region of the injector body 20 of the fuel injector 3. Below that head region, an annularly configured contact face 28 is embodied on the injector body 20, and the clamping body 29 rests on this contact face and presses the injector body 20 into a contact face 36 provided on the nozzle end of the injector body. The injector body 20 of the fuel injector 3 is likewise surrounded virtually entirely by the material comprising the cylinder head 5, either of a self-igniting internal combustion engine or of a direct-injection gasoline engine. The clamping body 29 includes a bore 30 for a clamping screw 31. By means of the clamping screw 31, the clamping body 29 is secured to the cylinder head 5. The clamping body 29 furthermore includes a support 33, which has a rounded feature 34. The rounded feature 34 of the support 33 on the clamping body 29 is braced on a plane face 32 of the cylinder head 5. By means of the proposed fastening capability, the injector body 20 of the fuel injector 3 can be removed very easily from the cylinder head 5 of the engine, once the clamping screw 31 is loosened and the clamping body 29 is removed by means of a tool that engages the annularly extending contact face 38 of the injector body 20 from underneath.

One or more injection openings 37 are located on the nozzle end of the injector body 20 and are opened and closed by an injection valve, not shown in the sectional view of FIG. 2, of the fuel injector 3. The injection openings 37 on the nozzle end of the injector body 20 of the fuel injector 3 subject a combustion chamber 38, shown in sketched form in FIG. 2, of a self-igniting internal combustion engine to fuel that is at high pressure.

Both in the variant embodiment shown in FIG. 1 and in the variant embodiment shown in FIG. 2 of the fuel reservoir 1 proposed according to the invention, the installation space available in the cylinder head 5 of an internal combustion engine is advantageously utilized. In the embodiments proposed by the invention, the stresses caused by the high pressures prevailing in a fuel reservoir 1 in the case where it is used in a self-igniting internal combustion engine are no longer absorbed solely by the wall of the fuel reservoir, designed in this case as a high-pressure fuel reservoir 1. In the first variant embodiment of the invention shown in FIG. 1, a high-pressure fuel reservoir 1 can be embodied as a recess 6. In the second variant embodiment, the wall 41 of the cylindrical tube 8 is surrounded virtually entirely by material 41 comprising the cylinder head 5, so that the material 42, which surrounds the wall 41 of the cylindrical tube, can be utilized for absorbing stresses. Moreover, by means of the provisions of the invention in both variant embodiments, not only fasteners for a fuel reservoir located on the outside of the cylinder head of the engine but also the installation space required for them on the outside of the cylinder head 5 can be dispensed with. In addition, the provisions of the invention make for especially easy installation and removal of the fuel injectors 3 or injector bodies 20 of the fuel injectors 3. Because of the material comprising the cylinder head 5 and surrounding the injector bodies 20 of the fuel injectors 3, uniform heat dissipation can be effected into the material comprising the cylinder head 5 of a self-igniting internal combustion engine.

In both types of engines, with only slight changes in view of the prevailing operating pressure level, that is, the fuel pressure, the integration proposed according to the invention of a fuel reservoir into a cylinder head 5 of an internal combustion engine, whether it is a self-igniting internal combustion engine or a direct-injection gasoline engine, makes use of the unused installation space at the cylinder head 5.

### LIST OF REFERENCE NUMERALS

1 Fuel reservoir
2 Fuel feed pump
3 Fuel injector
4 High-pressure line
5 Cylinder head
6 Cylindrical recess
7 Connecting conduits
8 Cylindrical tube
9 Sealing body
10 Fastening openings
11 Fuel tank
12 High-pressure line segment
13 Fuel feeding direction
14 Inner wall of cylindrical recess
15 Insert piece
16 Axis of symmetry of fuel injector 3
17 First branch
18 Second branch
19 Spacing from face end of cylindrical recess 6
20 Injector body
21 Wall of injector body
22 High-pressure bore
23 Angle
24 Protuberance on side toward injector
25 Through bore of sealing body 9
26 Recess toward reservoir for sealing body 9
27 Hollow chamber
28 Contact face of injector body
29 Clamping body
30 Bore of clamping body
31 Clamping screw
32 Plane face of cylinder head
33 Support for the clamping body
34 Rounded feature
35 Receptacle for injector head
36 Contact face of end of injector body toward nozzle
37 Injection opening
38 Combustion chamber
39 Target direction of insert core
40 Opening for cylindrical tube on side toward cylinder head
41 Tube wall
42 Surrounding cylinder head material

1-11. (canceled)

12. In a fuel injection system for supplying fuel to direct-injection internal combustion engines, having a central fuel reservoir (1) between a feed pump (2) and a plurality of injectors (3) to be supplied with fuel, which communicate with the central fuel reservoir (1), and the injectors (3) are mounted in a cylinder head (5) of the engine for direct injection of fuel into a plurality of combustion chamber, the improvement wherein the fuel reservoir (1) is at least partly integrated into the cylinder head (5).

13. The fuel injection system of claim 12, wherein the fuel reservoir (1) is formed partly or entirely by a recess (6) in the cylinder head (5).

14. The fuel injection system of claim 12, wherein the fuel reservoir (1) comprises a storage volume which is formed by a cylindrical, elongated recess (6) in the vicinity of and along the injectors (3) in the cylinder head (5).

15. The fuel injection system of claim 13, wherein the fuel reservoir (1) comprises a storage volume which is formed by a cylindrical, elongated recess (6) in the vicinity of and along the injectors (3) in the cylinder head (5).

16. The fuel injection system of claim 12, further comprising high-pressure lines (4) which are integrated, in the form of connecting conduits (7), into the cylinder head (5).

17. The fuel injection system of claim 13, further comprising high-pressure lines (4) which are integrated, in the form of connecting conduits (7), into the cylinder head (5).

18. The fuel injection system of claim 14, further comprising high-pressure lines (4) which are integrated, in the form of connecting conduits (7), into the cylinder head (5).

19. The fuel injection system of claim 12, wherein the fuel reservoir (1) is embodied as a cylindrical bore (6) in the cylinder head.

20. The fuel injection system of claim 13, wherein the fuel reservoir (1) is embodied as a cylindrical bore (6) in the cylinder head.

21. The fuel injection system of claim 14, wherein the fuel reservoir (1) is embodied as a cylindrical bore (6) in the cylinder head.

22. The fuel injection system of claim 16, wherein the fuel reservoir (1) is embodied as a cylindrical bore (6) in the cylinder head.

23. The fuel injection system of claim 12, wherein the cylinder head (1) is formed by an insert part in the operation of casting the cylinder head (5).

24. The fuel injection system of claim 13, wherein the cylinder head (1) is formed by an insert part in the operation of casting the cylinder head (5).

25. The fuel injection system of claim 14, wherein the cylinder head (1) is formed by an insert part in the operation of casting the cylinder head (5).

26. The fuel injection system of claim 16, wherein the cylinder head (1) is formed by an insert part in the operation of casting the cylinder head (5).

27. The fuel injection system of claim 12, wherein the fuel reservoir (1) is formed by a cylindrical tube (8), which is integrated into the cylinder head (5) in a bore (40) or recess (6).

28. The fuel injection system of claim 12, wherein the walls of the fuel reservoir (1) are formed by the material of the cylinder head (5) itself.

29. The fuel injection system of claim 12, wherein one sealing body (9) each is inserted between the fuel reservoir (1) and each of the injectors (3).

30. The fuel injection system of claim 12, wherein the fuel reservoir (1) for supplying fuel to direct-injection internal combustion engines is designed as a high-pressure reservoir.

31. In a cylinder head (5) for direct-injection internal combustion engines, for operating the engine in conjunction with a fuel injection system which has a central fuel reservoir (1) that communicates, via respective high-pressure connections (4), with a plurality of injectors (3), and the injectors (3) are mounted in fastening openings (10) in the cylinder head (5), the improvement wherein the high-pressure connections (4) and the fuel reservoir (1) are embodied as at least partly integrated into the cylinder head (5).
